(19) United States
(12) Patent Application Publication
(10) Pub. No.: US 2019/0005255 A1
(43) Pub. Date: Jan. 3, 2019

(54) PROTECTING RESTRICTED INFORMATION WHEN IMPORTING AND EXPORTING RESOURCES

(71) Applicant: Microsoft Technology Licensing, LLC, Redmond, WA (US)

(72) Inventors: Engy Ali Mohamed Morsy Ali, Bellevue, WA (US); Kyle Anthony Werner, Seattle, WA (US); David J. Messner, Redmond, WA (US)

(21) Appl. No.: 15/853,455

(22) Filed: Dec. 22, 2017

Related U.S. Application Data
(60) Provisional application No. 62/528,016, filed on Jun. 30, 2017.

(51) Int. Cl. G06F 21/62; G06F 9/50; G06F 9/30

(52) U.S. Cl. CPC G06F 21/62; G06F 2209/506; G06F 9/30; G06F 9/5005

(57) ABSTRACT

Aspects extend to methods, systems, and computer program products for protecting sensitive data when importing and exporting resources. When a user exports resources from a source environment into a package, restricted information (e.g., privacy settings, security settings, resource identifiers, customer information, etc.) from the source environment can be replaced with unrestricted surrogate information. When a user imports resources into a target environment from a package, unrestricted surrogate information can be replaced with restricted information from the target environment. When a user imports resources, suggestions can be provided to help the user select the appropriate resource based on prior import selects. Aspects of the invention can include at least two phases. A first phase can include exporting a package from a source environment and a second phase can include importing the package into a target environment.

### CROSS-REFERENCE TO RELATED APPLICATIONS

This application claims the benefit of and priority to U.S. Provisional Patent Application Ser. No. 62/528,016 entitled “IMPORTING AND EXPORTING RESOURCES BETWEEN ENVIRONMENTS WITH IMPORT IDENTIFIER SUGGESTIONS AND WITH SENSITIVE INFORMATION OBSCURED”, filed Jun. 30, 2017 by Engy Ali Mohamed Morsy Ali et al., the entire contents of which are expressly incorporated by reference.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

During the life of a software product, the software product may operate in several different environments (containers). For example, operation of a software product can transition between usage in a development environment, a test/staging environment, and a production environment. In another example, a software product can operate in a number of different geographically located (or compliance) environments. Each different environment can operate on an isolated set of underlying components (e.g., compute, storage, and network components) and may contain resources that are created and/or modified within that environment. Thus, separate environments provide isolation, preventing risks in one environment from spreading into other environments.

### BRIEF SUMMARY

Examples extend to methods, systems, and computer program products for protecting restricted information when importing and exporting resources between environments. In some aspects, an application runs in a source environment. A resource of the application is exported from the source environment. An export request is received requesting that the resource be exported from the source environment. The application is accessed based on an application identifier included in the export request.

Restricted information associated with the resource is identified in the source environment. Unrestricted surrogate information corresponding to the restricted information is located. Locating unrestricted surrogate information can include assigning unrestricted surrogate information to restricted information as well as accessing previously assigned unrestricted surrogate information that corresponds to restricted information from a storage location. The resource along with the unrestricted surrogate information is exported into a package.

In one aspect, an export request requests that the resource be exported from the source environment for a user. The resource and an assigned source resource identifier are accessed from a source environment. The assigned source resource identifier is used to identify the resource in the source environment. The assigned source resource identifier includes restricted information about the source environment.

The source resource identifier is replaced with a surrogate resource identifier for export. The contents of the surrogate resource identifier are unrelated to the source environment. The resource along with the surrogate resource identifier are exported into a package. Exporting the resource along with the surrogate resource identifier prevents the restricted information from being exported into the package.

In other aspects, an application runs in a target environment. A resource of the application is imported into the target environment. An import request is received requesting that the resource be imported into the target environment. The application is accessed based on an application identifier included in the import request.

Unrestricted surrogate information included in a package and that is associated with the resource is identified. Restricted information corresponding to the unrestricted surrogate information is located. Locating restricted information can include assigning restricted information to unrestricted surrogate information as well as accessing previously assigned restricted information that corresponds to unrestricted surrogate information from a storage location. The resource along with the restricted information is imported into the target environment.

In one aspect, an import request requests that a resource be imported into the target environment for a user. The resource and an assigned surrogate resource identifier are accessed from a package. The surrogate resource identifier was assigned to the resource when the resource was previously exported into the package from a source environment. The contents of the surrogate resource identifier are unrelated to the source environment and unrelated to the target environment.

The assigned surrogate resource identifier is replaced with a target resource identifier. The target resource identifier is used to identify the resource in the target environment. The target resource identifier contains restricted information about the target environment. The resource along with the target resource identifier are imported into the target environment. Importing the resource along with the assigned target resource identifier allows the resource to be appropriately identified in the target environment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example computer architecture that facilitates exporting a resource from an environment.

FIG. 2 illustrates a flow chart of an example method for exporting a resource from an environment.

FIG. 3 illustrates an example computer architecture that facilitates importing a resource into an environment.

FIG. 4 illustrates a flow chart of an example method for importing resource into an environment.

FIG. 5 illustrates an example data flow for exporting resources.

FIG. 6 illustrates an example data flow for importing resources.

### DETAILED DESCRIPTION

Examples extend to methods, systems, and computer program products for protecting restricted information when importing and exporting resources between environments. In some aspects, an application runs in a source environment. A resource of the application is exported from a source environment. An export request is received requesting that the resource be exported from the source environment. The application is accessed based on an application identifier included in the export request.

Restricted information associated with the resource is identified in the source environment. Unrestricted surrogate information corresponding to the restricted information is located. Locating unrestricted surrogate information can include assigning unrestricted surrogate information to restricted information as well as accessing previously assigned unrestricted surrogate information that corresponds to restricted information from a storage location. The resource along with the unrestricted surrogate information is exported into a package.

In one aspect, an export request requests that the resource be exported from the source environment for a user. The resource and an assigned source resource identifier are accessed from a source environment. The assigned source resource identifier is used to identify the resource in the source environment. The assigned source resource identifier includes restricted information about the source environment.

The source resource identifier is replaced with a surrogate resource identifier for export. The contents of the surrogate resource identifier are unrelated to the source environment. The resource along with the surrogate resource identifier are exported into a package. Exporting the resource along with the surrogate resource identifier prevents the restricted information from being exported into the package.

In other aspects, an application runs in a target environment. A resource of the application is imported into the target environment. An import request is received requesting that the resource be imported into the target environment. The application is accessed based on an application identifier included in the import request.

Unrestricted surrogate information included in a package and that is associated with the resource is identified. Restricted information corresponding to the unrestricted surrogate information is located. Locating restricted information can include assigning restricted information to unrestricted surrogate information as well as accessing previously assigned restricted information that corresponds to unrestricted surrogate information from a storage location. The resource along with the restricted information is imported into the target environment.

In one aspect, an import request requests that a resource be imported into the target environment for a user. The resource and an assigned surrogate resource identifier are accessed from a package. The surrogate resource identifier was assigned to the resource when the resource was previously exported into the package from a source environment. The contents of the surrogate resource identifier are unrelated to the source environment and unrelated to the target environment.

The assigned surrogate resource identifier is replaced with a target resource identifier. The target resource identifier is used to identify the resource in the target environment. The target resource identifier contains restricted information about the target environment. The resource along with the target resource identifier are imported into the target environment. Importing the resource along with the assigned target resource identifier allows the resource to be appropriately identified in the target environment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, it is beneficial to be able to copy resources between environments. For example, it can be beneficial to copy a tested resource from a test environment into a production environment. It may also be beneficial to copy a useful resource from one geographical environment to another geographical environment. Thus, many software product development systems include functionality to export resources from environments and import resources into environments. Accordingly, a resource can be exported from one environment and imported into another environment.

Aspects of the invention can include at least two phases. A first phase can include exporting a package and second phase can include importing a package.

An export service can copy (export) a resource from a source environment into a package using an export operation. The package is configured for import into other (target) environments. During export, the export service replaces restricted information from the source environment (e.g., privacy settings, security settings, source resource identifiers, customer information, etc.) with unrestricted surrogate information. For example, a source resource identifier used to identify the resource within the source environment can be replaced with a surrogate resource identifier. The surrogate resource identifier obscures any restricted information (e.g., customer specific information) contained in the source resource identifier. If a resource has not previously been exported or if it is otherwise appropriate to change unrestricted surrogate information for the resource, unrestricted surrogate information (e.g., surrogate privacy settings, surrogate security information, a surrogate resource identifier, etc.) can be created for the resource. During subsequent export of the resource, the unrestricted surrogate information can be retrieved from storage.

An import service can subsequently copy (import) the resource from the package into a target environment using a corresponding import operation. During import, the import service replaces unrestricted surrogate information with restricted information for the target environment. For example, surrogate resource identifier can be replaced with a target resource identifier used to identify the resource within the target environment. If a resource has not previously been imported or if it is otherwise appropriate to change restricted information for the resource, restricted information for the resource can be created. During subsequent import of the resource, the restricted information can be retrieved from storage.

In one aspect, a target environment is a different environment than the source environment. In another aspect, the source environment and the target environment are the same environment. In this other aspect, the import service can be used to create an additional copy of a resource in an environment from which the resource was exported.

The import service can include a user interface. The user interface can provide suggestions to a help a user select appropriate resources based on previous import selections. For example, the import service can suggest using a particular target resource identifier to identify a resource in the target environment. The user can choose to accept or override import service suggestions. The user interface can also include other controls to update resources, create resources, etc. based on restricted information (e.g., target resource identifiers) used or to be used in the other target environment.

In one aspect, an application or workflow in an environment includes a number of resources. During export of the application or workflow from the environment, an export service can replace restricted information with unrestricted surrogate information for each resource included in the application or workflow (e.g., replacing a source resource identifier with a surrogate resource identifier). The export service can copy (export) each resource and corresponding unrestricted surrogate information into a package. During subsequent import of the application or workflow into another target environment, an import service can replace unrestricted surrogate information with restricted information for the target environment. For example, a surrogate resource identifier can be replaced with a target resource identifier (either as suggested to a user and/or from user overrides) for each resource in the package. The import service can copy (import) each resource and corresponding restricted information into the target environment.

Accordingly, aspects of the invention include (but are not limited to) specific improvements to the security and user experience of import/export technology. Resources can be exported from one environment and imported into another environment without reduced functionality and without restricted information leaking between environments. During export, restricted information is replaced with unrestricted surrogate information. Replacing restricted information with unrestricted surrogate information improves security by protecting the restricted information from external exposure. When a user updates or targets a resource with an import operation, suggestions can be provided to the user to improve resource selection efficiency based on prior import selections. Improved resource selection efficiency simplifies import operations thereby improving the user experience.

Implementations may comprise or utilize a special purpose or general-purpose computer including computer hardware, such as, for example, one or more computer and/or hardware processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: export requests, import requests, restricted information, unrestricted information, surrogate information, application identifiers, source environment identifiers, surrogate identifiers, target environment identifiers, export tables, import tables, mappings, export table updates, import table updates, identifier requests, packages, resources, service suggestions, user interface data, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, export requests, import requests, restricted information, unrestricted information, surrogate information, application identifiers, source environment identifiers, surrogate identifiers, target environment identifiers, export tables, import tables, mappings, export table updates, import table updates, identifier requests, packages, resources, service suggestions, user interface data, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In general, export/import uses knowledge of downstream services to “templatize” (dehydrate) resource types and facilitates rehydration in a non-broken state. Export/import is supported for applications, workflows, etc.

In this description and the following claims, a “package” is defined as a transferrable data model of resources that can also include data related to orchestrating the import and export resources and data defining relationships between resources. A package can be a fully sanitized definition “template” for each resource within the package. That is, a package can be a resource template devoid of restricted information (e.g., identifiers containing customer information) as well as re-mapped dependencies using unrestricted surrogate information (e.g., identifies that do not contain customer information).

A package can include any data assets used to recreate a resource without loss of content, such as, for example, icons, embedded media, etc. A package can include a complete manifest of resource relationships and dependencies so that the orchestration process can enable the import of resources which are fully configured without user interaction. The manifest can define resource relationships as well as allowed user inputs for various configurable pieces, such as, for example, display name, secret parameters, and expected output files, that are enabled. A package can include resource-specific content which enables custom logic at the export/import layer of each resource type. If resource type “Foo” needs custom logic that is different than resource type “Bar,” it can be defined in a package.

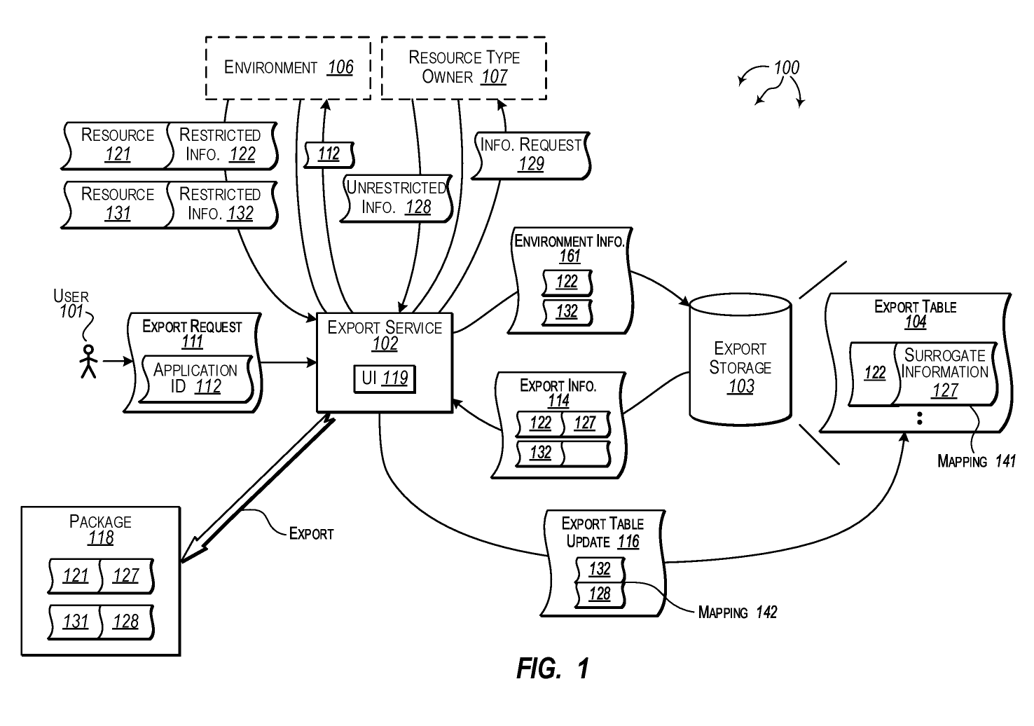

FIG. 1 illustrates an example computer architecture 100 that facilitates exporting a resource from an environment. As depicted, computer architecture 100 includes user 101, export service 102, export storage 103, environment 106, and resource type owner 107. User 101, export service 102, export storage 103, environment 106, and resource type owner 107 can be connected to (or be part of) a network, such as, for example, a system bus, a Local Area Network (“LAN”), a Wide Area Network (“WAN”), and even the Internet. Accordingly, user 101, export service 102, export storage 103, environment 106, and resource type owner 107 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In general, export service 102 is configured to export resources from source environments into packages. Resources can include: entities, picklists, permission sets, roles, applications, flows, connectors, gateways, custom Application Program Interfaces (APIs), etc. Resources in a source environment can be associated with restricted information, such as, for example, security settings, privacy settings, source resource identifiers, customer information, etc., of the source environment. In one aspect, source resource identifiers include customer specific information.

Export service 102 can receive export requests including application (or workflow) identifiers. Export service 102 can use an application (or workflow) identifier to identify resources associated with an application (or workflow) in a source environment. Export service 102 can access resources from the source environment and identify restricted information (e.g., privacy settings, security settings, source resource identifiers, customer information, other sensitive information, etc.) associated with accessed resources. For example, export service 102 can access a resource and identify a source resource identifier for the resource that includes sensitive information (e.g., customer specific information) associated with the source environment.

Export service 102 can identify restricted information associated with a resource based on a resource type of the resource, how an application (or workflow) uses the resource, the content of a resource, etc. In one aspect, an access policy defines resources that are associated with restricted information. Export service 102 can check the access policy to determine if a resource is associated with restricted information.

Export service 102 can replace restricted information (e.g., source resource identifiers) with unrestricted surrogate information (e.g., resource identifiers including information unrelated to aspects of the source environment). Export storage 103 stores export tables mapping restricted information to unrestricted surrogate information. In one aspect, export storage 103 stores an export table that maps restricted information to unrestricted surrogate information for all source environments. In another aspect, export storage 103 stores a different export table for each source environment that maps restricted information to unrestricted surrogate information for that source environment.

For each portion of restricted information (e.g., for each privacy setting, for each security setting, for each source resource identifier, etc.), export service 102 can check export storage 103 for a mapping from the restricted information to corresponding unrestricted surrogate information. If a mapping is located, export service 102 accesses the unrestricted surrogate information from the mapping and replaces the restricted information (e.g., source resource identifier or privacy setting) with the unrestricted surrogate information (e.g., surrogate resource identifier or surrogate privacy setting) for the resource.

If a mapping is not located, export service 102 can obtain (e.g., generate, request, locate, etc.) unrestricted surrogate information for the resource. Unrestricted surrogate information can be obtained based on a resource type of a resource, how an application uses a resource, the content of a resource, etc. In one aspect, based on a resource type, export service 102 requests unrestricted surrogate information (e.g., a surrogate resource identifier) from a resource type owner for the resource. In response to the request, the resource type owner sends unrestricted surrogate information (e.g., the surrogate resource identifier) to export service 102. Export service 102 can receive the unrestricted surrogate information from the resource type owner.

Export service 102 replaces the restricted information (e.g., source resource identifier) with the obtained unrestricted surrogate information (e.g., surrogate resource identifier). Export service 102 also updates the corresponding export table with a mapping from the restricted information (e.g., the source resource identifier) to the received unrestricted surrogate information (e.g., the surrogate resource identifier). As such, the unrestricted surrogate information can be accessed from export storage 103 if the resource is subsequently exported.

Export service 102 can export (copy) resources and corresponding unrestricted surrogate information into a package. Since unrestricted surrogate information is unrelated to the source environment, restricted information is not leaked outside of the source environment.

Export service 102 includes user interface 119 (e.g., a graphical user interface). A user desiring to export resources from a source environment can use user interface 119 to select the resources.

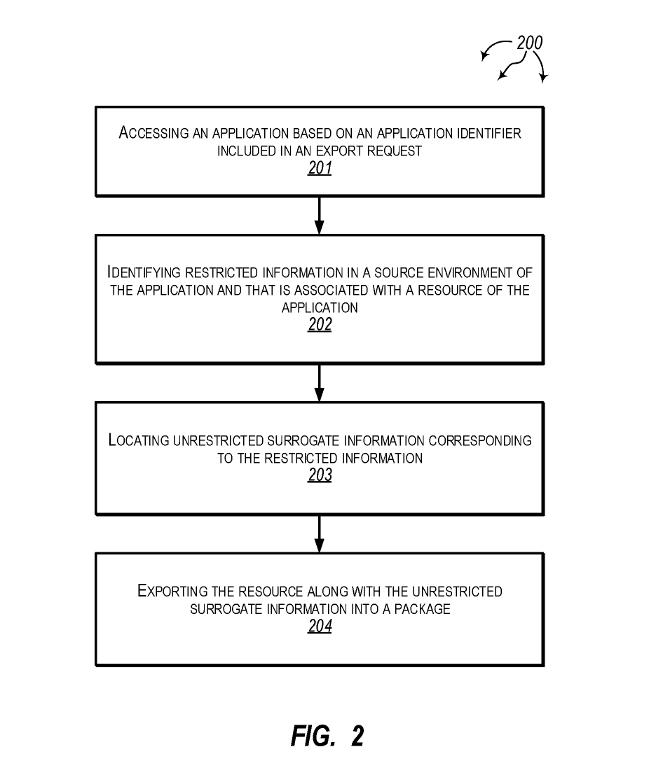

FIG. 2 illustrates a flow chart of an example method 200 for exporting a resource from an environment. Method 200 will be described with respect to the components and data of computer architecture 100.

User 101 can be an administrator of (source) environment 106. User 101 may desire to export resources 121 and 131 (e.g., from an application or workflow) used in (source) environment 106. User 101 can use user interface 119 to select resources 121 and 131 for export. User 101 can send export request 111 including application ID 112 (or a workflow ID or an ID identifying some other grouping of resources) to export service 102. Export service 102 can receive export request 111 from user 101.

Method 200 includes accessing an application based on an application identifier included in an export request (201). For example, export service 102 can access an application (or workflow or other resource grouping) from (source) environment 106 based on application ID 112 included export request 111.

Export request 111 can also include individual resource identifiers or individual resource identifiers can be determined from application ID 112. Thus, export request 111 can request that one or more specified resources be exported from (source) environment 106 for user 101.

Method 200 includes identifying restricted information in a source environment of the application and that is associated with a resource of the application (202). For example, export service 102 can identify restricted information 122 in environment 106 and that is associated with resource 121. Export service 102 can also identify restricted information 132 in (source) environment 106 and that is associated with resource 131.

Export service 102 can identify restricted information 122 associated with resource 121 based on a resource type of resource 121, how an application (or workflow) in (source) environment 106 uses resource 121, the content of resource 121, etc. In one aspect, export service 102 can check an access policy to determine that resource 121 is associated with restricted information 122. Similarly, export service 102 can identify restricted information 132 associated with resource 131 based on a resource type of resource 131, how an application (or workflow) in (source) environment 106 uses resource 131, the content of resource 131, etc. In one aspect, export service 102 can check an access policy to determine that resource 131 is associated with restricted information 132.

It may be that restricted information 122 and 132 include resource identifiers used to identify resources 121 and 131 respectively in (source) environment 106. The resource identifiers can include restricted information about (source) environment 106, such as, for example, customer information associated with user 101.

Method 200 includes locating unrestricted surrogate information corresponding to the restricted information (203). For example, export service 102 can locate unrestricted surrogate information 127 corresponding to restricted information 122. Similarly, export service 102 can locate unrestricted surrogate information 128 corresponding to restricted information 132. Export service 102 can replace restricted information 122 with unrestricted surrogate information 127. Similarly, export service 102 can replace restricted information 132 with unrestricted surrogate information 128.

More specifically, export service 102 can query export storage 103 with environment information 161 including restricted information 122 and 132. In one aspect, unrestricted surrogate information is accessed from storage. For example, using restricted information 122, export storage 103 can identify mapping 141 in export table 104. As depicted, mapping 141 maps restricted information 122 to unrestricted surrogate information 127. Using restricted information 132, export storage 103 may be unable to identify a corresponding mapping.

Export storage 103 can send export information 114 to export service 102. Export information 114 indicates that restricted information 122 maps to unrestricted surrogate information 127 and that restricted information 132 does not currently map to unrestricted surrogate information. Export service 102 can receive export information 114 from export storage 103. Export service 102 can then replace restricted information 122 with unrestricted surrogate information 127. Unrestricted surrogate information 127 can contain information unrelated to (source) environment 106.

In another aspect, unrestricted surrogate information is assigned to restricted information. For example, based on restricted information 132 not mapping to unrestricted surrogate information, export service 102 can determine a resource type for resource 131. Based on the resource type for resource 131, export service 102 can send information request 129 to resource type owner 107 to request unrestricted surrogate information for resource 131. Resource type owner 107 can receive information request 129. Resource type owner 107 can generate unrestricted surrogate information 128 for assignment to restricted information 132 in response to information request 129. Resource type owner 107 can send unrestricted surrogate information 128 to export service 102. Export service 102 can receive unrestricted surrogate information 128 from resource type owner 107. Unrestricted surrogate information 128 can contain information unrelated to (source) environment 106.

Export service 102 can also communicate with other resource type owners (not shown) to obtain unrestricted surrogate information for other types of resources.

Export service 102 can replace restricted information 132 with unrestricted surrogate information 128. Export service 102 can also send export table update 116 to export storage 103. Export table update 116 updates export table 104 with mapping 142 that maps restricted information 132 to unrestricted surrogate information 128 (i.e., assigns unrestricted information 128 to restricted information 132). Export service 102 can refer to mapping 142 when resource 131 is subsequently exported.

Method 200 includes exporting the resource along with the unrestricted surrogate information into a package (204). For example, export service 102 can export resource 121 with unrestricted surrogate information 127 and resource 131 with unrestricted surrogate information 128 into package 118. Since unrestricted surrogate information 127 and 128 contain information unrelated to (source) environment 106, restricted information from (source) environment 106 is not exported out of (source) environment 106 and into package 118.

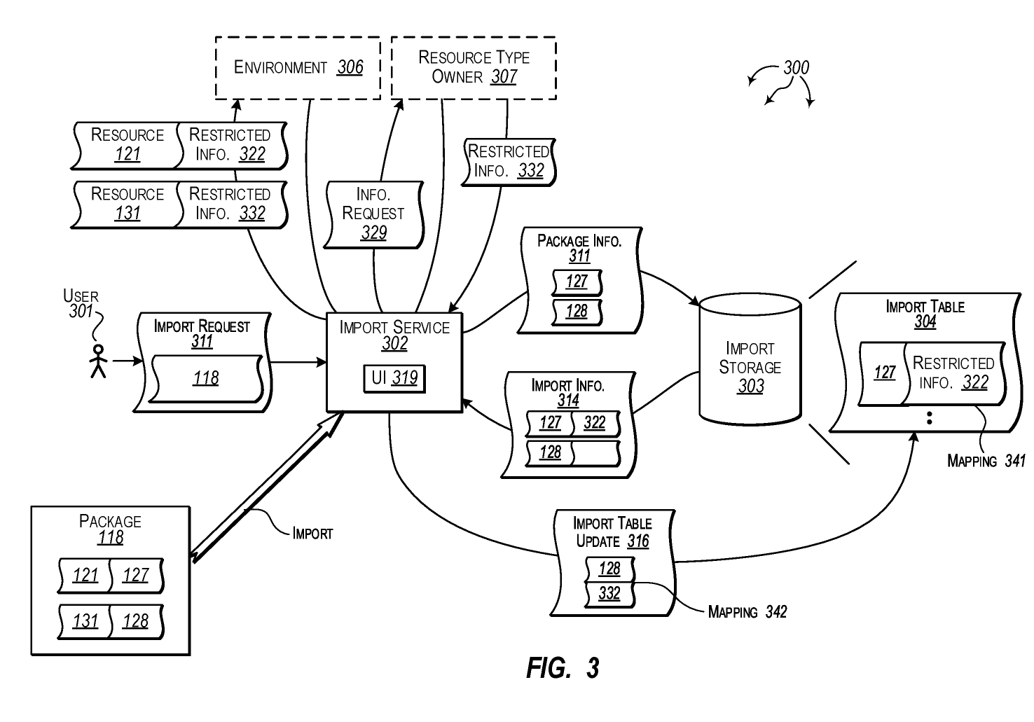

FIG. 3 illustrates an example computer architecture 300 that facilitates importing a resource into an environment. As depicted, computer architecture 300 includes user 301, import service 302, import storage 303, target environment 306, and resource type owner 307. User 301, import service 302, import storage 303, target environment 306, and resource type owner 307 can be connected to (or be part of) a network, such as, for example, a system bus, a Local Area Network (“LAN”), a Wide Area Network (“WAN”), and even the Internet. Accordingly, user 301, import service 302, import storage 303, target environment 306, and resource type owner 307 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In general, import service 302 is configured to import resources from packages into target environments. Resources can include: entities, picklists, permission sets, roles, applications, flows, connectors, gateways, custom Application Program Interfaces (APIs), etc. Resources in a package can be associated with unrestricted surrogate information, such as, for example, surrogate security settings, surrogate privacy settings, surrogate resource identifiers, surrogate customer information, etc., of the source environment. In one aspect, surrogate resource identifiers do not include customer specific information.

Import service 302 can receive import requests to import packages containing resources and surrogate resource identifiers. Import service 302 can use a package identifier or application (or workflow) identifier to identify that resources in a package are associated with an application (or workflow) (e.g., that is to run) in a target environment. Import service 302 can access resources and corresponding unrestricted surrogate information (e.g., surrogate privacy settings, surrogate security settings, surrogate resource identifiers, surrogate customer information, other surrogate sensitive information, etc.) from a package. For example, import service 302 can access a resource and corresponding surrogate resource identifier for the resource. The surrogate resource identifier can include information not associated with a source environment and not associated with a target environment.

Import service 302 can replace unrestricted surrogate information with restricted information of at target environment (e.g., privacy settings, security settings, resource identifiers, customer information, other sensitive information related to the target environment, etc.). Import service 302 can identify restricted information associated with a resource based on a resource type of the resource, how an application (or workflow) uses the resource, the content of a resource, etc. In one aspect, an access policy defines resources that are associated with restricted information. Export service 302 can check the access policy to determine if a resource is associated with restricted information.

Import storage 303 stores import tables mapping unrestricted surrogate information to restricted information o. In one aspect, import storage 303 stores an import table that maps unrestricted surrogate information to restricted information for all target environments. In another aspect, import storage 303 stores a different import table for each target environment that maps unrestricted surrogate information to restricted information for that target environment.

For each portion of unrestricted surrogate information (e.g., for each surrogate privacy setting, for each surrogate security setting, for each surrogate resource identifier, etc.), import service 302 can check import storage 303 for a mapping from the unrestricted surrogate information to corresponding restricted information. If a mapping is located, import service 302 accesses the restricted information from the mapping and replaces the unrestricted surrogate information (e.g., surrogate resource identifier or surrogate privacy setting) with the restricted information (e.g., target resource identifier or privacy setting) for the resource.

If a mapping is not located, import service 302 can obtain (e.g., generate, request, locate, etc.) restricted information for the resource. Restricted information can be obtained based on a resource type of a resource, how an application uses a resource, the content of a resource, etc. In one aspect, based on a resource type, import service 302 requests restricted information (e.g., a target resource identifier) from a resource type owner for the resource. In response to the request, the resource type owner sends restricted information (e.g., the target resource identifier) to import service 102. Import service 302 can receive the restricted information from the resource type owner.

Import service 302 replaces the unrestricted surrogate information (e.g., surrogate resource identifier) with the obtained restricted information (e.g., the target resource identifier). Import service 302 also updates the corresponding import table with a mapping from the unrestricted surrogate information (e.g., the surrogate resource identifier) to the received restricted information (e.g., the target resource identifier). As such, the restricted information can be accessed from import storage 303 if the resource is subsequently imported.

Import service 302 can import (copy) resources and corresponding restricted information into a target environment.

Import service 302 includes user interface 319 (e.g., a graphical user interface). A user desiring to import resources into a target environment can use user interface 319 to select resources. User interface 319 can provide suggestions to help a user select appropriate resources based on previous import selections. For example, the import service 302 can suggest using a target resource identifier to identify a resource in a target environment. The user can choose to accept or override import service suggestions. User interface 319 can also include other controls to update resources, create resources, etc. based on restricted information (e.g., target resource identifiers) used or to be used in a target environment.

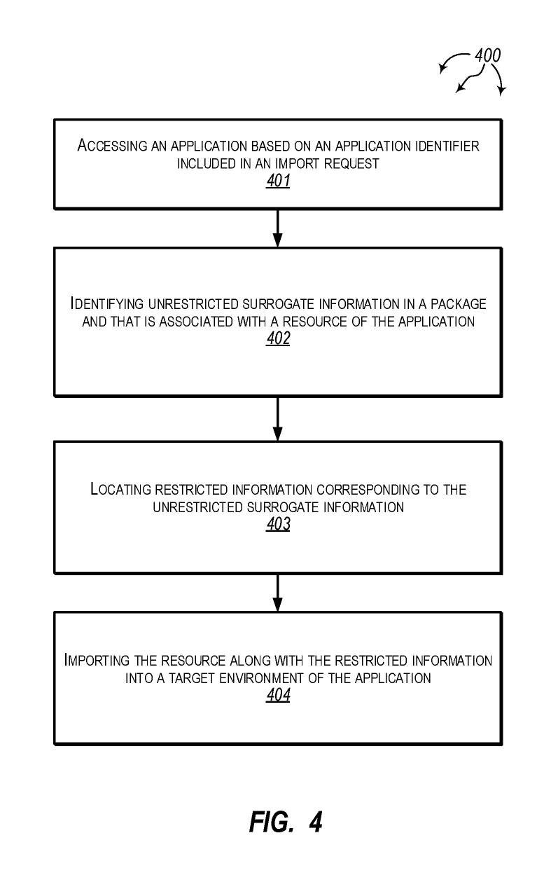

FIG. 4 illustrates a flow chart of an example method 400 for importing a resource into an environment. Method 400 will be described with respect to the components and data of computer architecture 300.

User 301 can be an administrator of source environment 306. User 301 may desire to import resources (e.g., for an application or workflow) into in environment 306. User 301 can use user interface 319 to select resources 121 and 131 for import. User 301 can send import request 311 including identifying information for package 118 (e.g., a package ID, an application ID, a workflow ID, or an ID identifying some other grouping of resources) to service 302. Import service 302 can receive import request 311 from user 301.

Method 400 includes accessing an application based on an application identifier included in an import request (401). For example, import service 302 can access an application (or workflow or other resource grouping) from package 118 based on the identifying information included import request 311.

Import request 311 can also include individual resource identifiers or individual resource identifiers can be determined from the identifying information. Thus, import request 311 can request that one or more specified resources be imported from package 118 for user 101.

Method 400 includes identifying unrestricted information in a package and that is associated with a resource of the application (402). For example, import service 302 can identify unrestricted surrogate restricted information 127 in package 118 and that is associated with resource 121. Export service 102 can also identify unrestricted surrogate information 128 in package 118 and that is associated with resource 131.

Method 400 includes locating restricted information corresponding to the unrestricted surrogate information (403). For example, import service 302 can locate restricted information 322 corresponding to unrestricted surrogate information 127. Similarly, import service 302 can locate restricted information 332 corresponding to unrestricted surrogate information 128. Import service 302 can replace unrestricted surrogate information 127 with restricted information 322. Similarly, import service 302 can replace unrestricted surrogate information 128 with restricted information 132.

Import service 302 can identify restricted information 322 associated with resource 121 based on a resource type of resource 121, how an application (or workflow) in (target) environment 306 uses resource 121, the content of resource 121, etc. In one aspect, import service 302 can check an access policy to determine that resource 121 is associated with restricted information 322. Similarly, import service 302 can identify restricted information 332 associated with resource 131 based on a resource type of resource 131, how an application (or workflow) in (target) environment 306 uses resource 131, the content of resource 131, etc. In one aspect, import service 302 can check an access policy to determine that resource 131 is associated with restricted information 332.

It may be that restricted information 322 and 332 include resource identifiers used to identify resources 121 and 131 respectively in (target) environment 306. The resource identifiers can include restricted information about (target) environment 306, such as, for example, customer information associated with user 301.

More specifically, import service 302 can query import storage 303 with package information 311 including unrestricted surrogate information 127 and 128. In one aspect, restricted information is accessed from storage. For example, using unrestricted surrogate information 127, import storage 303 can identify mapping 341 in import table 304. As depicted, mapping 341 maps unrestricted surrogate information 127 to restricted information 322. Using unrestricted surrogate information 128, import storage 303 may be unable to identify a corresponding mapping.

Import storage 303 can send import information 314 to import service 302. Import information 314 indicates that unrestricted surrogate information 127 maps to restricted information 322 and that unrestricted surrogate information 128 does not currently map to restricted information. Import service 302 can receive import information 314 from import storage 303. Import service 302 can then replace unrestricted surrogate information 127 with restricted information 322. Restricted information 322 can contain information related to (target) environment 306.

In another aspect, restricted information is assigned to unrestricted surrogate information. For example, based on unrestricted surrogate information 128 not mapping to restricted information, import service 302 can determine a resource type for resource 131. Based on the resource type for resource 131, import service 302 can send information request 329 to resource type owner 307 to request restricted information for resource 131. Resource type owner 307 can receive information request 329. Resource type owner 307 can generate restricted information 332 for assignment to unrestricted surrogate information 128 in response to information request 329. Resource type owner 107 can send restricted information 328 to export service 302. Export service 302 can receive restricted information 328 from resource type owner 307. Restricted information 328 can contain information related to (target) environment 306.

Import service 302 can present restricted information (e.g., target resource identifier) suggestions at user interface 319. The suggestions can include associating restricted information 322 with resource 121 and associating restricted information 332 with resource 131. User 301 can accept the suggestions presented at user interface 319. In response, import service 302 can then replace unrestricted surrogate information 127 with restricted information 322 and replace unrestricted surrogate information 128 with restricted information 332. Alternately, user 301 may choose to override one or more presented suggestions, including selecting or creating other restricted information to associate with resources 121 and 131 in (target) environment 306. When other restricted information is created or selected, the user created or selected restricted information can be used to replace unrestricted surrogate information 127 and/or 128.

Import service 302 can also communicate with other resource type owners (not shown) to obtain restricted information for other types of resources.

Import service 302 can replace unrestricted surrogate information 128 with restricted information 332. Import service 302 can also send import table update 316 to import storage 303. Import table update 316 updates import table 304 with mapping 342 that maps unrestricted surrogate information 128 to restricted information 332 (i.e., assigns restricted information 332 to unrestricted information 128). Export service 302 can refer to mapping 342 when resource 131 is subsequently imported.

Method 400 includes importing the resource along with the restricted information into a target environment of the application (404). For example, import service 302 can import (copy) resource 121 along with restricted information 322 and resource 131 along with restricted information 322 into (target) environment 306. Restricted information 322 and 332 allow resources 121 and 131 respectively to be appropriately utilized in (target) environment 306.

In some aspects, export service 102 and import service 302 are included as part of another common service. In other aspects, export service 102 and import service 302 run as separate services.

In some aspects, a resource is exported from environment 106 and then imported back into environment 106 to create an additional copy of the resource in environment 106. Method 400 or a similar method can be used to import the resource into environment 106. Accordingly, multiple copies of a resource can be included in an environment. Different resource identifiers can be used to distinguish different copies of the same resource included in an environment.

As described, aspects of the invention can utilize a two phase approach. A first phase includes exporting a package. A second phase includes importing the package.

In a first phase, a user requests to export resource(s) (1). The export request is received by a platform service (2). The platform service queries export storage with the restricted information (e.g., source resource identifiers) provided in the request to check whether the resources have been previously exported for the same user and source environment (3). The platform service generates unrestricted surrogate information (e.g., new surrogate resource identifiers, such as, GUIDs) for newly exported resources, links the unrestricted surrogate information with the corresponding restricted information, and then saves the link back to the storage (4). The generated package contains the unrestricted surrogate information (e.g., the new surrogate resource identifier) for each resource (5).

In a second phase, user requests to import the package (1). The import packaging is received by the platform service (2). The platform service extracts the unrestricted surrogate information (e.g., the surrogate resource identifiers) (3). The platform service queries import storage to check if the resources being imported have been previously imported in the target environment for the same user (4). The platform service then links each resource with corresponding restricted information (e.g., a target resource identifier) and provides the suggested resources to the user (5). For newly imported resources, the platform service links restricted information (e.g., the target resource identifiers) generated by service partners with the unrestricted surrogate information (e.g., the surrogate resource identifiers) specified in the package and saves the link to the storage for further import packaging solutions (6).

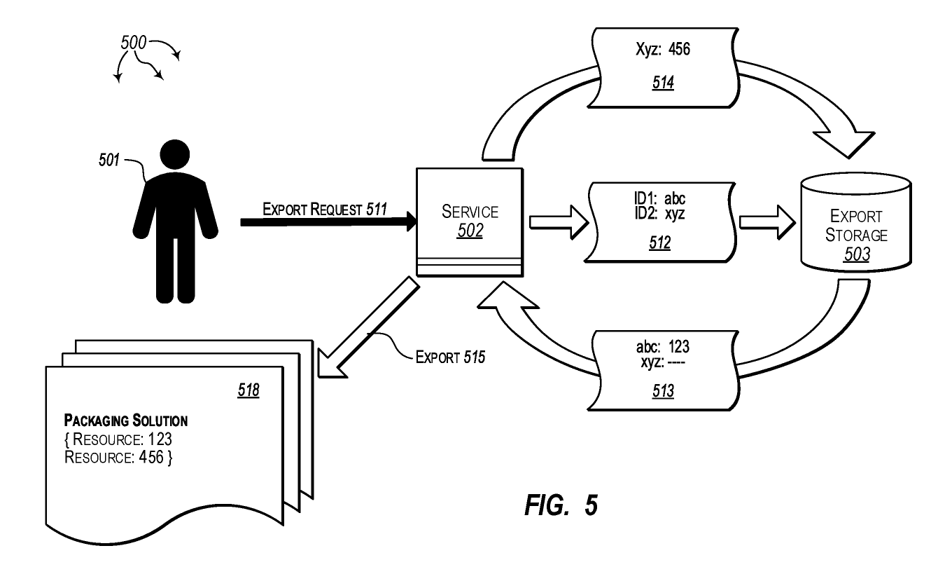

FIG. 5 illustrates an example data flow 500 for exporting resources. User 501 can send export request 511 to service 502. Service 502 can query 512 export storage 503 for surrogate identifiers corresponding to source identifiers “abc” and “xyz”. Export storage 503 can return surrogate IDs 513 to service 502. Surrogate IDs 513 indicate that source identifier “abc” maps to surrogate identifier “123” and that source identifier “xyz” does not map to a known surrogate identifier.

Service 502 obtains surrogate identifier “456” (e.g., from a resource type owner) for source identifier “xyz”. Service 502 sends export update 514 to export storage 503 to store a mapping from source identifier “xyz” to surrogate identifier “456”. Service 502 exports 515 resources with surrogate identifiers “123” and “456” into packaging solution 518.

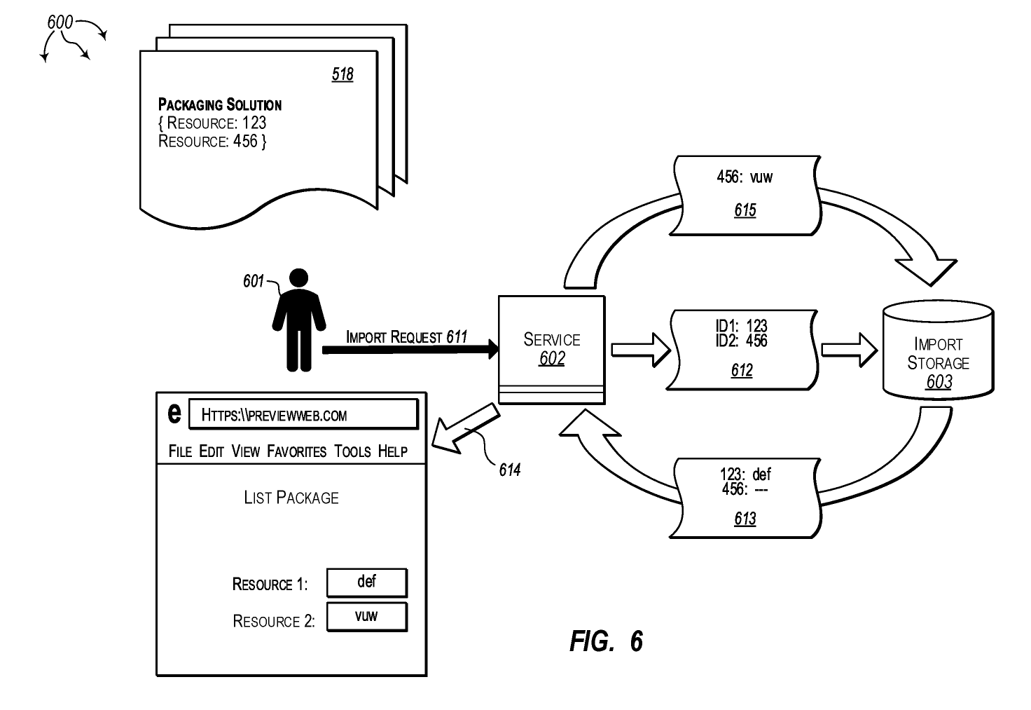

FIG. 6 illustrates an example data flow 600 for importing resources. User 601 can send import request 611 to service 602. Service 602 can query 612 import storage 603 for target identifiers corresponding to surrogate identifiers “123” and “456”. Import storage 603 can return target IDs 613 to service 602. Target IDs 613 indicate that surrogate identifier “123” maps to target identifier “def” and that surrogate identifier “456” does not map to a known target identifier.

Service 602 obtains target identifier “vuw” (e.g., from a resource type owner) for surrogate identifier “456”. Service 602 suggests 614 replacing surrogate identifier “123” with target identifier “def” and replacing surrogate identifier “456” with target identifier “vuw”. User 601 can accept the suggestions 614. Service 602 sends import update 614 to import storage 603 to store a mapping from surrogate identifier “456” to target identifier “vuw”. Service 602 copies resources from package solutions 518 into a target environment using target identifiers “def” and “vuw”.

In one aspect, a package can be in a compressed format, for example, similar to a ZIP file.

A single platform service can be used to manage imports and exports from a plurality of different environments. The platform service can include an export service and an import service. For example, export service 102 and import service 302 can be included in the same platform service and may include a common user interface. The platform service can interact with a combined set of resource source type owners. For example, resource type owners 107 and 307 can be combined or may be the same resource type owners.

Accordingly, a platform service can manage unrestricted surrogate information for resources. The platform service can also assign unrestricted surrogate information per environment that map back to original resources. Per environment, the unrestricted surrogate information can be used for reverse mapping.

Aspects of the invention can be used in a development environment to develop an application or workflow (e.g., by 3rd party developer, ISV, etc.). The development environment (or user) can assign GUID to each resource used by the application or workflow. The GUID may be derived from a user's ID. To prevent leakage of user's ID as embodied in the GUID, surrogate IDs can be created.

The various components depicted in described computer architectures can be connected to (or be part of) a network, such as, for example, a system bus, a Local Area Network (“LAN”), a Wide Area Network (“WAN”), and even the Internet. Accordingly, the various components as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In some aspects, a computer system comprises one or more hardware processors and system memory. The one or more hardware processors execute instructions stored in the system memory to automatically perform any of the described functionality. In other aspects, computer implemented methods can be used to perform any of the described functionality. In further aspects, computer program products include computer-executable instructions, that when executed at a processor, cause a computer system to perform any of the described functionality.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A computer system, comprising:
a processor; and
system memory coupled to the processor and storing instructions configured to cause the processor to:
access an application based on an application identifier included in an export request;
identify restricted information in a source environment of the application and that is associated with a resource of the application;
locate unrestricted surrogate information corresponding to the restricted information; and
export the resource along with the unrestricted surrogate information into a package.

2. The computer system of claim 1, wherein the instructions configured to cause the processor to locate unrestricted surrogate information comprise instructions configured to cause the processor to access a mapping between the restricted information and the unrestricted surrogate information.

3. The computer system of claim 1, wherein the instructions configured to cause the processor to locate unrestricted surrogate information comprise instructions configured to cause the processor to obtain the unrestricted surrogate information based on a resource type of the resource.

4. The computer system of claim 1, further comprising the instructions configured to cause the processor to store a mapping between the restricted information and the unrestricted surrogate information.

5. The computer system of claim 1, wherein instructions configured to cause the processor to identify restricted information that is associated with a resource of the application comprise instructions configured to cause the processor to identify the restricted information based on a resource type of the resource.

6. The computer system of claim 1, wherein instructions configured to cause the processor to identify restricted information that is associated with a resource of the application comprise instructions configured to cause the processor to identify the restricted information based on content in a resource identifier of the resource.

7. The computer system of claim 1, wherein instructions configured to cause the processor to identify restricted information associated with a resource of the application comprise instructions configured to cause the processor to check an access policy indicating that the resource is associated with the restricted information.

8. The computer system of claim 1, wherein instructions configured to cause the processor to identify restricted information that is associated with a resource of the application comprises instructions configured to cause the processor to identify the restricted information based on how the application uses the resource in the source environment.

9. The computer system of claim 1, wherein instructions configured to cause the processor to identify restricted information associated with a resource of the application comprise instructions configured to cause the processor to identify a resource identifier of the resource that includes the restricted information;
wherein instructions configured to cause the processor to locate unrestricted surrogate information corresponding to the restricted information comprise instructions configured to cause the processor to locate a surrogate resource identifier corresponding to the resource identifier; and
wherein instructions configured to cause the processor to export the resource along with the unrestricted surrogate information into a package comprise instructions configured to cause the processor to export the resource along with the surrogate resource identifier into the package.

10. A computer system, comprising:
a processor; and
system memory coupled to the processor and storing instructions configured to cause the processor to:
access an application based on application identifier included in an import request;
identify unrestricted surrogate information in a package and that is associated with a resource of the application;
locate restricted information corresponding to the unrestricted surrogate information; and
import the resource along with the restricted information into a target environment of the application.

11. The computer system of claim 10, wherein the instructions configured to cause the processor to locate restricted information comprise instructions configured to cause the processor to access a mapping between the unrestricted surrogate information and the restricted information.

12. The computer system of claim 10, wherein the instructions configured to cause the processor to locate restricted information comprise instructions configured to cause the processor to obtain the restricted information based on a resource type of the resource.

13. The computer system of claim 10, further comprising the instructions configured to cause the processor to store a mapping between the unrestricted surrogate information and the restricted information.

14. The system of claim 10, wherein the instructions configured to cause the processor to locate restricted information comprise instructions configured to cause the processor to receive the restricted information through a user interface.

15. The computer system of claim 14, wherein the instructions configured to cause the processor to receive the restricted information through a user interface comprise instructions configured to cause the processor to:
present the restricted information as suggested restricted information at the user interface; and
receive an indication through a user interface control that the suggested restricted information is accepted.

16. The computer system of claim 10, wherein instructions configured to cause the processor to import a resource of the application and corresponding unrestricted surrogate information associated with the resource comprise instructions configured to cause the processor to identify a resource identifier of the resource that contains the unrestricted surrogate information;
wherein instructions configured to cause the processor to locate restricted information corresponding to the unrestricted surrogate information comprise instructions configured to cause the processor to locate a target resource identifier corresponding to the surrogate resource identifier; and
wherein instructions configured to cause the processor to transfer the resource along with the restricted information to a target environment comprise instructions configured to cause the processor to transfer the resource along with the target resource identifier into the target environment.

17. A method comprising:
accessing an application based on an application identifier included in an export request;
identifying restricted information in a source environment of the application and that is associated with a resource of the application;
locating unrestricted surrogate information corresponding to the restricted information; and
exporting the resource along with the unrestricted surrogate information into a package.

18. The method of claim 17, wherein identifying restricted information in a source environment of the application comprises identifying restricted information based on one or more of: a resource type of the resource, content in a resource identifier of the resource, or how the application uses the resource in the source environment.

19. The method of claim 17, wherein locating unrestricted surrogate information corresponding to the restricted information comprises locating unrestricted surrogate information by one or more of: accessing a mapping between the restricted information and the unrestricted surrogate information or receiving the unrestricted surrogate information from a resource type owner for the resource.

20. The method of claim 17, further comprising storing a mapping between the restricted information and the unrestricted surrogate information subsequent to locating the unrestricted surrogate information
